(19) United States
(12) Patent Application Publication
(10) Pub. No.: US 2005/0066057 A1
(43) Pub. Date: Mar. 24, 2005

(54) Method and arrangement in a communications network

(76) Inventors: Tommy Thorstensson, Bromma (SE); Orjan Reinholdsen, Taby (SE); Lars-Erik Sellin, Alvsjo (SE)

Correspondence Address: NIXON PEABODY, LLP, 401 9TH STREET, NW, SUITE 900, WASHINGTON, DC, 20004-2128, US

(21) Appl. No.: 10/493,029

(22) PCT Filed: Sep. 27, 2002
(86) PCT No.: PCT/SE02/01765

(30) Foreign Application Priority Data
Oct. 19, 2001 (SE) 0103485-9

(51) Int. Cl. G06F 15/16

(52) U.S. Cl. 709/246; 380/270

(57) ABSTRACT

The present invention relates to a method and arrangement in a communications system and more specifically to digital signatures sent over bandwidth restricted connections. The objective of the present invention is to provide a way to enable a mobile public network user to use his/her mobile device (104) for performing digital signing of data suitable for being transferred partially over a bandwidth restricted radio link to a receiver (102) such as a payment server or similar. A digital signature is created within a mobile device (104) and transferred the over the radio access network (108) to the gateway (110), a certificate associated to the specific mobile device is retrieved by means of an agent (116) associated to the gateway (110), said retrieved certificate is attached to the digital signature by means of said agent (116); and said digital signature and attached certificate forwarded over the Internet (106) to the receiver (102).

### FIELD OF THE INVENTION

The present invention relates to a method and arrangement in a communications system in accordance with the preambles of the independent claims. More specifically it relates to digital signatures sent over bandwidth restricted connections.

### BACKGROUND OF THE INVENTION

To attain security in open networks, several security solutions have appeared. One example is Public key Infrastructure (PKI). PKI is a system to distribute and check keys that can be used to authenticate users, sign information and encrypt information. In a PKI system, two associated keys are used in connection with protecting information. One important feature of PKI systems is that it is computationally unfeasible to use knowledge of one of the keys to deduce the other key, such keys being called asymmetric keys. In a typical PKI system, a set of two such keys are assigned to an owner. One of the keys is maintained private while the other is freely published. When the keys are used for encryption of information, the information is encrypted with the public key and only the owner having the private key can decrypt it. As only the owner possesses the private key, the keys can be used for digital signatures when used in the opposite way. Thus, when the keys are used for signing, the information is encrypted with the private key by the owner and the signature can be verified by the public key.

A PKI distributes one or several public keys. A central element of a Public Key Infrastructure are public key certificates, which are needed to provide assurance of the validity of public keys. A trusted third party issues certificates and is called a certification authority (CA). The CA uses its good name to guarantee the correctness of a public key by signing a certificate including the public key and other information.

According to International Organization for Standardization (ISO) 7498-2, a digital signature is data appended to, or cryptographic transformation of a data unit that allows a recipient of the data unit to prove the source and integrity of the data unit and protect against forgery, e.g. by the recipient.

A recipient of a digitally signed message (relying party), in this document referred to as the receiver, is someone that wants to prove the source and integrity of the message and verify the sender of that particular message. With a trusted third party in a PKI the recipient may know that the public key provided to him/her is the right one and is corresponding to the senders identity. This is assured by the trusted third party through a Certificate.

Digital signatures made by means of said public key processes, are generated by means of the private key with a mathematical algorithm and the signature can be verified with the associated public key. The private key can be controlled only by the signer that owns the key so that nobody is able to sign in the name of the signer. The public key, on the other hand may be published so that anybody can verify the signature. The private key is usually protected through a Personal Identification Number (PIN) so that for making a signature, knowledge of the PIN and possession of the private key are required.

The digital signatures can be generated in a computer, e.g. in a PC, by means of computer programs consisting of such a mathematical algorithm. The private key is usually stored on a hard disk or a diskette and downloaded into the main memory for generating the signature. Mostly, the private key is stored encoded and protected via a PIN, which the owner has to enter when signing by means of the computer program. This will ensure that only the owner of the private key can use the private key for signing. Since no additional software is required, this process is advantageous in regard to costs.

Digital signatures are widely used in the fixed Internet world, which is a public open network. One way to use digital signing is to send a signing request from a signature recipient to a computer of a user. The user receives the request and signs it by using his private key, e.g. in a smart card within the computer, containing the necessary private key. The signature is sent back to the signature recipient in a message. Optionally the client may attach the user's certificate to the message sent back to the signature recipient

The use of digital signatures in the mobile Internet word or other public network is becoming more and more common. The European patent application EP 102784 shows a process for digital signing of a message and describes the use of a mobile radio telephone net for transmitting signed messages. However, this document is silent about attaching certificates to such a message.

A certificate comprises lots of information and requires a great deal of bandwidth when transferred and a lot of memory capacity for storing. As the storage capacity of mobile devices is limited and the bandwidth of the radio communication channel it uses for the transfer to the recipient is restricted there ate problems with storing the certificate and transferring the digital signature and added certificate over radio connection to the recipient when using a mobile device to perform the digital signing, adding the correspondent certificate to it and transfer it to the recipient that requested the digital signature.

### SUMMARY OF THE INVENTION

The object of the present invention is to provide a way to enable a mobile Internet or other public network user to use his/her mobile device for performing digital signing of data suitable for being transferred over a bandwidth restricted radio link to a receiver such as a signature recipient application, e.g. a payment server or similar.

The problem is solved by a method having the features of claim 1 and a device having the features of claim 8.

The method, comprising the steps of transferring a digital signature over the radio access network to the gateway, retrieving a certificate associated to the specific mobile device by means of an agent associated to the gateway, attaching said certificate to the digital signature by means of said agent; and forwarding said digital signature and attached certificate over the Internet or other public network to the receiver, makes it possible to transfer the digital signature without the certificate over the bandwidth restricted radio link.

Thanks to that the agent, associated to the gateway, has access to a directory wherein certificates are stored and that the agent has means for retrieving a certificate associated to a specific mobile device and attach it to the digital signature when transferring it on to the receiver, associated certificates do not have to be transferred over the bandwidth restricted radio link.

Preferred embodiments are shown in the independent claims.

An advantage of the present invention is that certificates do not have to be stored on a signature client with limited storage capacity, nor transmitted over a communication channel with restricted bandwidth and receivers may still receive digital signatures with certificates attached in the same way as receiving digital signatures from fixed Internet or other public network clients with sufficient storage capacity and bandwidth.

### BRIEF DESCRIPTION OF THE DRAWINGS

FIG. 1 is a block diagram illustrating an exemplary digital signature system according to the present invention.

FIG. 2 is a block diagram depicting a mobile device according to the present invention.

FIG. 3 is a signalling sequence diagram showing an example of the signing method according to the present invention.

### DETAILED DESCRIPTION OF PREFERRED EMBODIMENTS

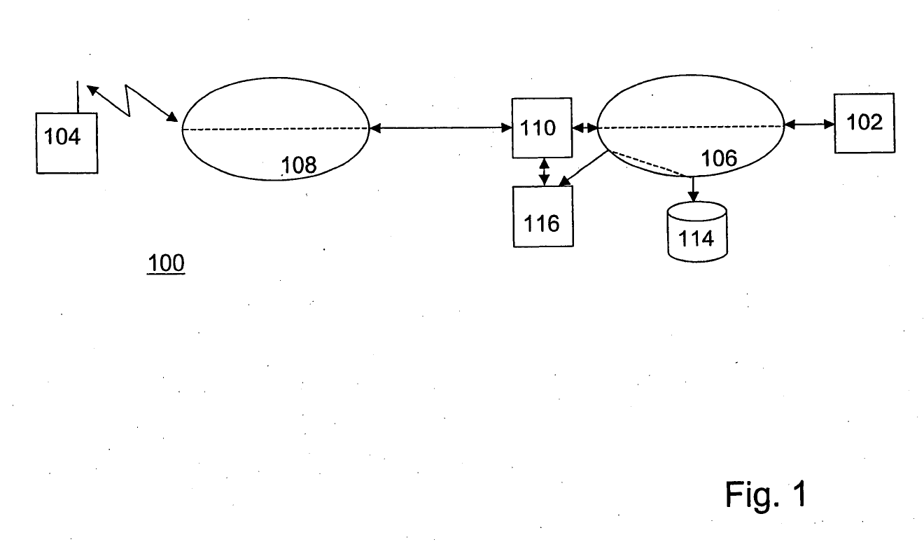

FIG. 1 is a block diagram illustrating an exemplary digital signature system 100 wherein a receiver such as a signature recipient application 102 wishes to ensure that a mobile end-user is who he/she claims to be. The system comprises a mobile device 104 such as e.g. a Mobile Station, adapted to be used by an end-user. In this example the mobile device 104 is accessible to the public network Internet 106 over a mobile access network 108 and via a wireless public network gateway i.e. in this example a wireless Internet gateway 110 constituting an entry into the public network, i.e. in this example the Internet 106.

The digital signature system 100 uses asymmetric cryptography, as being part of a PKI, for performing digital signatures. A pair of keys, consisting of a private key and a public key, is assigned to the user. The key pair is associated to a certificate, e.g. a X.509 certificate, through a certification process, whereby the public key is bound to an identity and thereby also the private key. X.509 is a standard by the International Telecommunications Union (ITU) specifying the contents of a digital certificate. The certificate issuing in a PKI is performed by a CA, Certificate Authority. Hence, the certificate is a trusted source for the RECEIVER to receive the signer identity or other certified information. A mobile user identity may be e.g. a name, birthday number, Mobile Station International ISDN Number (MSISDN) and/or Integrated Circuit Card Identification number (ICCID).

The Receiver

The receiver may for example be an internet bank application, a payment server or any application in the need of authentication (ensuring the identity of another party) or non-repudiation (preventing the denial of previous action). The receiver 102 is connectable to the Internet 106 and is able to communicate with the mobile device 102 of the end user. The receiver 102 is typically implemented as a software application, such as e.g. an internet web server application, running on a computer hardware. The receiver 102 has the ability to verify the digital signature.

The Mobile Device

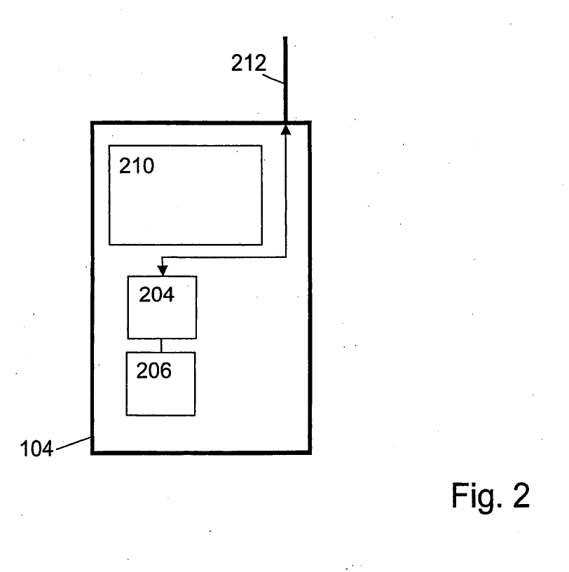

The mobile device 104, depicted in FIG. 2, may be a mobile station, a pager, a Personal Digital Assistant (PDA), etc. that the user wishes to use for proving for the receiver that he/she is who he/she claims to be, or ensuring the commitment of an action such as signing a payment transaction. The mobile device 104 comprises a transmitting and a receiving means 212 for radio communication with mobile access network 108. The mobile device 104 comprises a client software 204 such as e.g. a WAP User Agent or wireless Internet browser which may be placed on e.g. the mobile equipment or a smart card of the mobile device 104, which may be a SIM card if the mobile device 104 is a GSM Mobile Station. The client software 204 is adapted for communicating with the mobile Internet gateway 110. The mobile device 104 further comprises a signing means 206 with the ability to perform digital signatures by means of mathematical algorithms on data sent to the mobile device 104. The signing means 206 and the user's private key which e.g. is used for signing of data, is preferably located in a tamper proof device such as a smart card. The mobile device 104 further comprises a displayer 210 wherein messages to be signed may be displayed and input means, e.g. a keyboard, by means of which the user may enter a PIN code for access to the private key for performing the signature.

The Wireless Public Network Gateway and the Agent

Referring to FIG. 1, the wireless internet gateway 110, from now on called the gateway, is the entry to the public network, in this example the Internet 106, for the mobile device 104 or more specific the mobile station based client software 204 as shown in FIG. 2.

The mobile client 204 communicates with a server within the gateway 110. According to the present invention a so-called certificate agent 116 is associated to the gateway 110. This agent is adapted to assisting the mobile device 104, in its performance of the digital signature procedure, by handling certificates. The agent 116 is able to access a directory 114, e.g. via the Internet, which directory 114 contains certificates, each of them associated to a mobile user e.g. by means of the identity of the mobile device 104 or the identity of the smart card of the mobile device 104. More than one certificate may be associated to one mobile device. The certificate(s) are put into the directory by the Certificate Authority when issuing the certificate(s). This is however outside the scope of this document.

The directory 114 may be a X.500 directory accessed by means of a X.500 directory protocol (X.500 is a Directory Standard defined by ISO and the ITU) or a Lightweight Directory Access Protocol (LDAP) (defined in RFC 2251).

Upon receipt in the gateway 110 of a signed message on its way from the user to the receiver 102, the signed message is forwarded to the agent 116. The agent 116 then retrieves the specific mobile user certificate in the directory 114 by matching a user identity, such as the Mobile Station International ISDN Number (MSISDN) and/or Integrated Circuit Card Identification number (ICCID), as a search criteria. The agent 116 attaches the certificate(s) to the signed message, returns the message back to the gateway that forwards it to the receiver 102.

The Cryptographic Message

The digital signature as well as certificates may be contained within a cryptographic message structure such as e.g. PCKS#7, referred to in RFC 2315 as Cryptographic Message Syntax Version 1.5. (RFC is short for Request for Comments, a series of notes about the Internet.)

Signing Procedure

Referring to FIG. 1, an exemplary scenario could be a mobile user that wishes to e.g. buy a CD at a web site or pay a bill in an Internet bank. The receiver 102 requests for a signature from the mobile device 104 of the user to ensure that a mobile end-user is who he/she claims to be. The user signs the message e.g. by means of the smart card of the mobile device 104. Instead of transferring the associated certificate from the mobile device 104 to the receiver 102 over a radio carrier with limited bandwidth each time a signing is performed as in prior art, the certificate is in the invention attached to the digital signature created on the mobile device, by the certificate agent 116 associated to the wireless Internet gateway. The completed signature is then forwarded to the receiver 102 which verifies it.

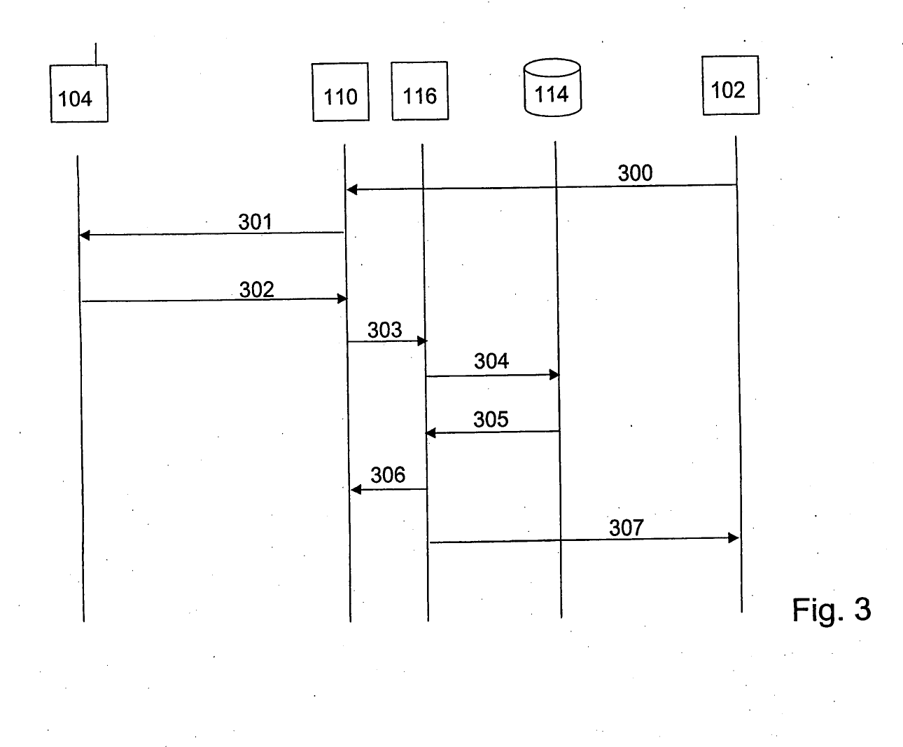

The signing method according to the present invention will now be described more in detail referring to the signalling diagram in FIG. 3. The method comprises the following steps:

Step 300
For the receiver 102 to be able to receive a digital signature from the mobile user, the receiver 102 sends a signing request message such as a message in a predefined and agreed protocol including a calling mechanism to the signature capability of the mobile device. The message is sent to the mobile user, i.e. to the mobile client 204 within the user's mobile device 104 as referred to in FIG. 2, via the gateway 110. The receiver 102 may also add Instructions/parameters for the agent 116 indicating what service to be performed. The possible instructions/parameters are embedded in the signature request message together with the signature request as well as in a subsequent message from the mobile device 104 to the gateway 110 together with the digital signature. The agent 116 will later in step 306 act in accordance with the Instructions/parameters.
Example of input parameters are:
What type of output format of the cryptographic message is requested, e.g. PKCS#7 or WAP SignedString?
Should the content be sent back to the receiver 102 with the PKCS#7 message?

Step 301
The gateway 110 receives the message and forwards it to the signing means 206 within the mobile device 104.

Step 302
The mobile device 104 receives the signature request message. The signing means 206 may display the text to be signed in the displayer 210 of the mobile device 104 and prompting the user for his/her PIN. The user enters his/her signing Personal Identification Number (PIN) to the signing means 206 by means of the input means. The signing means 206 obtains the PIN and verifies the PIN. If the correct PIN is entered, the signing means 206 is allowed to access the private key for performing the cryptographic calculation forming the digital signature. The signing means 206 returns the digital signature to the mobile client software 204 which in turn sends the digital signature over the bandwidth restricted mobile access network 108 to the gateway 110, possibly together with parameters provided in the original message from the receiver 102. The digital signature is transferred in a message.

Step 303
The gateway 110 receives the digital signature message and relays it to the agent 116.

Step 304
After receiving the digital signature message, the agent 116 accesses the directory 114.

Step 305
It retrieves the certificate or certificates of the specific user by means of e.g. an identity of the mobile device 104 or the identity of the smart card such as Mobile Station International ISDN Number (MSISDN) or Integrated Circuit Card Identification number (ICCID), from which the signature carrying message came.

Step 306
If parameters/instructions is included in the message, the agent 116 performs different operations in accordance with these parameters/instructions. One typical instruction would be that the agent 116 attaches the certificates and creates a PKCS#7 message structure containing the certificate and the digital signature. The new message structure, e.g. PKSC#7, is passed back to the gateway 110. If a user has multiple certificates, all certificates may be sent.

Step 307
The gateway 110 forwards the signature and certificate, comprised in a message to the receiver 102.

The method is implemented by means of a computer program product comprising the software code means for performing the steps of the method. The computer program product is run on a computer placed in the gateway domain and implements a certificate handling entity within the digital signature system. The computer program is loaded directly or from a computer usable medium, such as a floppy disc, a CD, the Internet etc.

The present invention is not limited to the above-described preferred embodiments. Various alternatives, modifications and equivalents may be used. Therefore, the above embodiments should not be taken as limiting the scope of the invention, which is defined by the appending claims.

1-12. (Canceled)

13. A method for performing a digital signature between a wireless mobile device attached to a mobile access network and a receiver attached to a public network, said networks conjoined by a gateway therebetween, said method comprising the steps of:
forwarding, from said mobile device, a signature of the user of said mobile device over the mobile access network to said gateway;
retrieving, from a certification agent connected to said gateway, at least one certificate associated with said user of said mobile device;
attaching said signature, received from said mobile device, to said at least one certificate, received from said certification agent; and
forwarding a message, with an attachment containing said signature and said at least one certificate, over said public network to the receiver.

14. The method according to claim 13, wherein said step of retrieving further comprises:
relaying, from said gateway to said certification agent, said signature.

15. The method according to claim 13, wherein said step of retrieving further comprises:
accessing, by said certification agent, a directory connected to said public network, said directory storing a plurality of certificates associated with a plurality of mobile devices.

16. The method according to claim 15, further comprising the step of:
identifying said at least one certificate within said directory associated with said user.

17. The method according to claim 16, wherein, in said step of identifying, the identification employs use of an identity of the mobile device or an identity of a smart card of said user.

18. The method according to claim 17, wherein said identification employs use of an identifier selected from the group consisting of: the signature, a Mobile Station International (ISDN Number (MSISDN), an Integrated Circuit Card Identification number (ICCID), a name and a birthday number.

19. The method according to claim 13, wherein, in said step of attaching, said certification agent creates said message containing said signature and said at least one certificate therein.

20. The method according to claim 19, wherein said certification agent creates a PKCS#7 message structure.

21. The method according to claim 19, wherein, in said step of forwarding, said message is first forwarded to said gateway.

22. The method according to claim 13, wherein, in said step of forwarding said message, the receiver is selected from the group consisting of: an Internet web server application, a public network node, and another mobile device connected to a mobile access network.

23. The method according to claim 13, wherein said signature and said at least one certificate employ an asymmetric cryptographic algorithm or Public Key Infrastructure mechanism.

24. An article of manufacture comprising a computer usable medium having computer readable program code means embodied thereon for facilitating a digital signature between a wireless mobile device attached to a mobile access network and a receiver attached to a public network, said networks conjoined by a gateway therebetween, the computer readable program code means in said article of manufacture comprising:
(a) computer readable program means for receiving a signature of the user of said mobile device;
(b) computer readable program means for retrieving, from a certification agent connected to said gateway, at least one certificate associated with said user of said mobile device; and
(c) computer readable program means for attaching said signature and said at least one certificate to a message.

25. The article of manufacture according to claim 24, wherein said computer readable program means are loaded onto a medium, said medium selected from the group consisting of: internal memory of a processing means within a computer connected to the certification agent, internal memory of a processing means within a computer connected to the gateway, and onto a computer usable medium.

26. The article of manufacture according to claim 25, wherein the computer usable medium comprises a floppy disk, a CD and a site on the Internet.

27. A certification agent within a communications system having a wireless mobile device attached to a mobile access network and a receiver attached to a public network, said networks conjoined by a gateway therebetween, said certification agent connected to said gateway and comprising:
means for accessing a directory connected to said public network, said directory containing a plurality of certificates therein; and
means for retrieving from said directory at least one of said certificates, said at least one certificate being associated with a user of said mobile device; and
means for attaching said at least one certificate to a signature of said user.

28. The certification agent according to claim 27, wherein said means for retrieving further comprises:
means for identifying said at least one certificate within said directory associated with said user.

29. The certification agent according to claim 28, wherein said means for identifying employs use of an identity of the mobile device or an identity of a smart card of said user

30. The certification agent according to claim 27, wherein said means for attaching further comprises:
means for creating a message containing said signature and said at least one certificate therein.

31. The certification agent according to claim 30, wherein said message is a PKCS#7 message structure.
